(19) United States
(12) Patent Application Publication
(10) Pub. No.: US 2010/0229116 A1
(43) Pub. Date: Sep. 9, 2010

(54) Control aparatus

(75) Inventors: Fumihiko Murase, Nagoya-city (JP); Ichiro Akahori, Anjo-city (JP); Shinji Niwa, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/659,348

(22) Filed: Mar. 4, 2010

(30) Foreign Application Priority Data
Mar. 5, 2009 (JP) 2009-51990

(51) Int. Cl. G10L 15/04; G06F 3/048

(52) U.S. Cl. 715/810; 704/251; 704/E15.005

(57) ABSTRACT

A control apparatus includes a voice recognition unit for recognizing user utterance to output a recognized word, a function storage unit for determining and storing a desired function that corresponds to the recognized word, a detector for detecting a preset user operation, a button display unit for displaying on a screen a shortcut button that instructs execution of the desired function stored in the storage unit when the detector detects the preset user operation, and a control unit for controlling execution of the desired function when the shortcut button is operated. By storing the desired function in association with the recognized word and by detecting user instruction, the control apparatus displays a shortcut button for a necessary function only.

### CROSS REFERENCE TO RELATED APPLICATION

The present application is based on and claims the benefit of priority of Japanese Patent Application No. 2009-51990, filed on Mar. 5, 2009, the disclosure of which is incorporated herein by reference.

### FIELD OF THE INVENTION

The present invention is generally relates to a control apparatus which has an operation reception function.

### BACKGROUND INFORMATION

Conventionally, a destination setting operation in the navigation, apparatus has been performed by utilizing speech recognition for an easy input of destination name or the like, as disclosed in, for example, JP-A-2008-14818 (Japanese patent document 1). In the above patent document, driver's conversation with navigator and/or monologue is speech-recognized, and the recognition results are used to determine a desired function and its parameters, and are further used to determine a screen that corresponds to the desired function and its parameters to display a shortcut button on the screen.
Japanese patent document 1: JP-A-2008-14818

When a desired function and its parameters are determined from the speech recognition result by the navigation apparatus as disclosed in the above Japanese patent document 1, the corresponding shortcut button is immediately displayed on the screen. However, the speech recognition result is not yet 100% correct, and the reject rate for rejecting a non-catalogued word that is not in the recognition dictionary is not very high. Thus, as a result, a shortcut button that is not relevant to the conversation/monologue is often displayed on the screen by the technique in the above patent document. Further, as the number of conversation/monologues increases, the number of shortcut buttons increases on the screen, thereby making it annoying, bothering and inconvenient for the user.

### SUMMARY OF THE INVENTION

In view of the above and other problems, the present invention provides a control apparatus that prevents an excessive display of shortcut buttons on the screen.

In an aspect of the present invention, the control apparatus includes: a voice recognition unit for recognizing a user voice to output a word or a series of words; a function storage unit for determining and storing a function that corresponds to the word or the series of words recognized by the voice recognition unit; a detector for detecting a preset user movement; a button display unit for displaying on a screen a shortcut button that instructs execution of the function stored in the storage unit when the detector detects the preset user movement; and a control unit for controlling execution of the function when the shortcut button is operated.

In other words, the control apparatus of the present invention displays the shortcut button on the screen only when the user performs a predetermined operation, thereby preventing the display of unnecessary shortcut buttons, one after another, on the screen.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of the configuration of a control apparatus in an embodiment of the present invention;

FIG. 2 is a block diagram of the configuration of a voice recognition unit in the control apparatus;

FIG. 3 is an illustration of a tree structure of menus;

FIG. 4 is a flowchart of a process which the control apparatus executes;

FIG. 5 is a flowchart of another process which the control apparatus executes;

FIG. 6 is an illustration of screen transition which the control apparatus executes;

FIG. 7 is a flowchart of a process which the control apparatus executes in another embodiment of the present invention;

FIG. 8 is a flowchart of another process which the control apparatus executes;

FIG. 9 is an illustration of screen transition which the control apparatus executes;

FIG. 10 is a flowchart of a modified process which the control apparatus executes;

FIG. 11 is a block diagram of the configuration of the control apparatus in yet another embodiment of the present invention;

FIG. 12 is a flowchart of a process which the control apparatus executes;

FIG. 13 is an illustration of screen transition which the control, apparatus executes;

FIG. 14 is a flowchart of a modified process which the control apparatus executes; and

FIG. 15 is an illustration of modified screen transition which the control apparatus executes.

### DETAILED DESCRIPTION

The embodiment of the present invention is described in the following.

### 1. First Embodiment

### (1) Configuration of a Control Apparatus 1

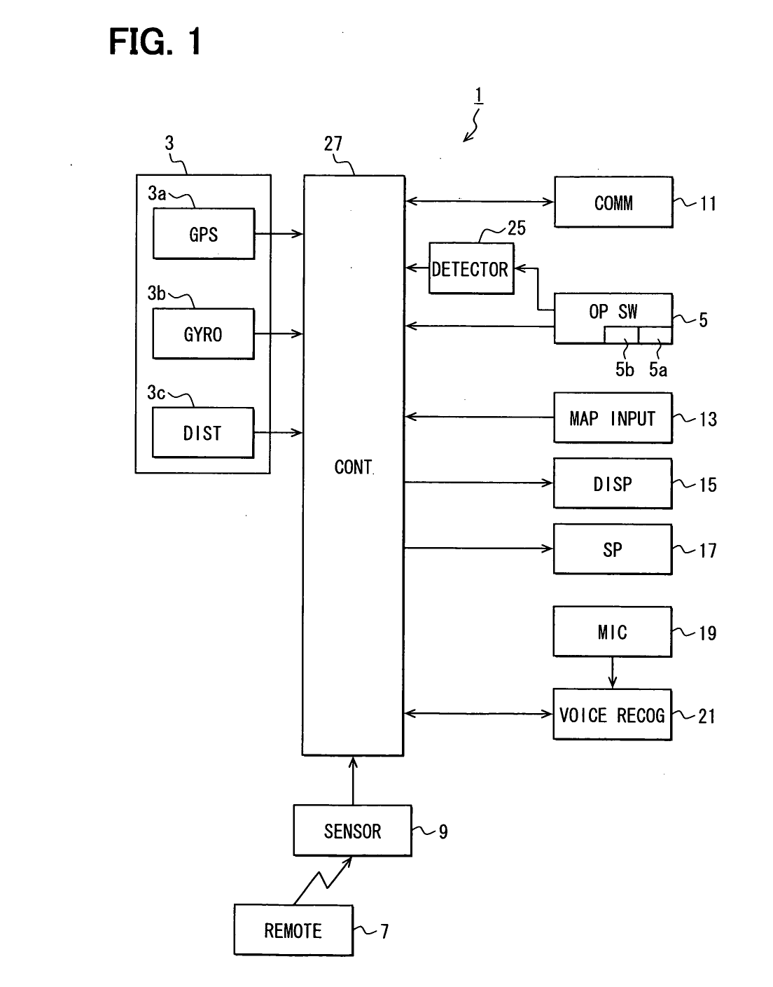

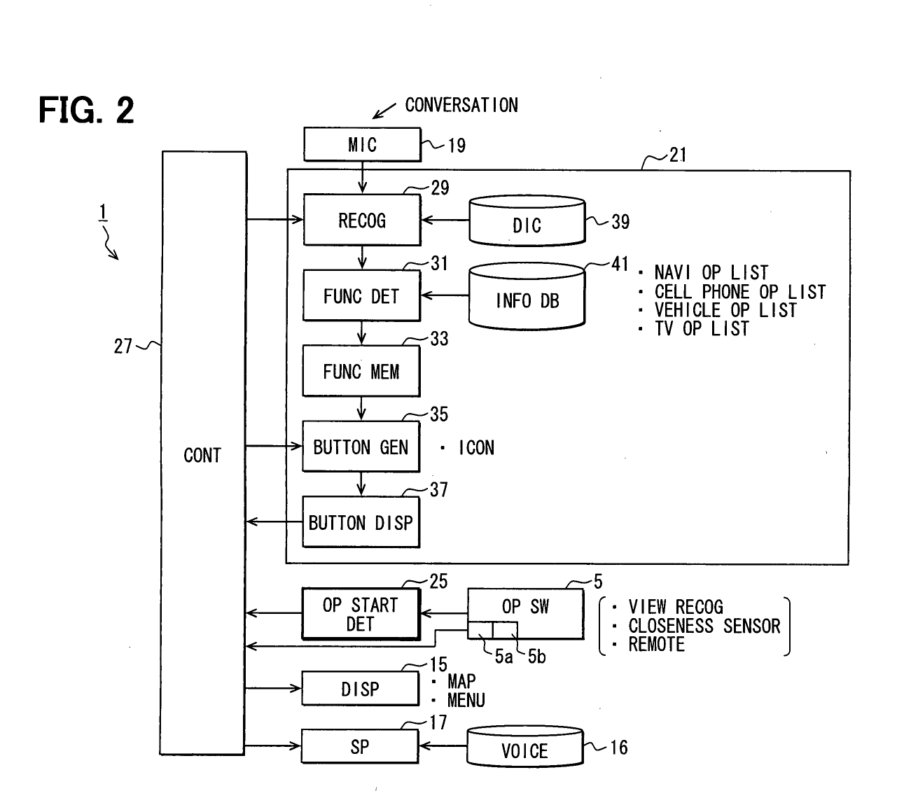

The configuration of a control apparatus 1 is described based on FIGS. 1 and 2. FIG. 1 is a block configuration diagram of the control apparatus 1, and FIG. 2 is a block configuration diagram which mainly shows the configuration of a voice recognition unit 21.

The control apparatus 1 is an apparatus disposed in a vehicle for providing the navigation function and the information input/output function from/to an outside including telephone capability. The control apparatus 1 includes a position detector 3 for detecting a vehicle position, an operation switch 5 for inputting various user instructions, a remote controller 7 for inputting various user instructions, a remote sensor 9 separately disposed from the control apparatus 1 for inputting signals from the remote controller 7, a communication apparatus 11, a map data input unit 13 for reading, from an information medium, information such as map data and other information, a display unit 15 for displaying maps and the information, a speaker 17 for outputting guidance sound and voices, a microphone 19 for inputting user's voice and outputting voice information, a voice recognition unit 21 for performing voice recognition related processes, an operation start detector 25 for detecting a start of an operation of an operation start button 5a in the operation switch 5, and a control unit 27 for controlling the above-described components such as communication apparatus 11, the display unit 15, the speaker 17, the voice recognition unit 21 and the like, based on the input from the operation switch 5 and the like.

The position sensor 3 includes a GPS signal receiver 3a for receiving signals of Global Positioning System and determining vehicle position/direction/speed and the like, a gyroscope 3b for detecting rotation of the vehicle body, and a distance sensor 3c for detecting a travel distance of the vehicle based on a front-rear direction acceleration of the vehicle. These components 3a to 3c are configured to operate in a mutually-compensating manner for correcting errors.

The operation switch 5 includes a touch panel on a screen of the display unit 15, a mechanical switch around the display unit 15 and the like. The touch panel layered on the screen may detect user's touch by various methods such as a pressure detection method, an electro-magnetic method, an electro-static method, or a combination of those methods. The operation switch includes the operation start button 5a mentioned above and a menu operation button 5b.

The communication apparatus 11 is an apparatus for communication with a communication destination that is specified by communication destination information. A cellular phone or the like may serve as the communication apparatus 11.

The map data input unit 13 is the equipment to input the data of various kinds from the map data storage media (e.g., the hard disk drive, a DVD-ROM and the like), which is not illustrated. In the map data storage media, map data such as node data, link data, cost data, background data, road data, name data, mark data, intersection data, facility data and the like are stored together with guidance voice data and voice recognition data. The data in the storage media may alternatively be downloaded from the communication network.

The display unit 15 may be a color display equipment such as a liquid crystal display, an organic electro-luminescent display, a CRT and the like.

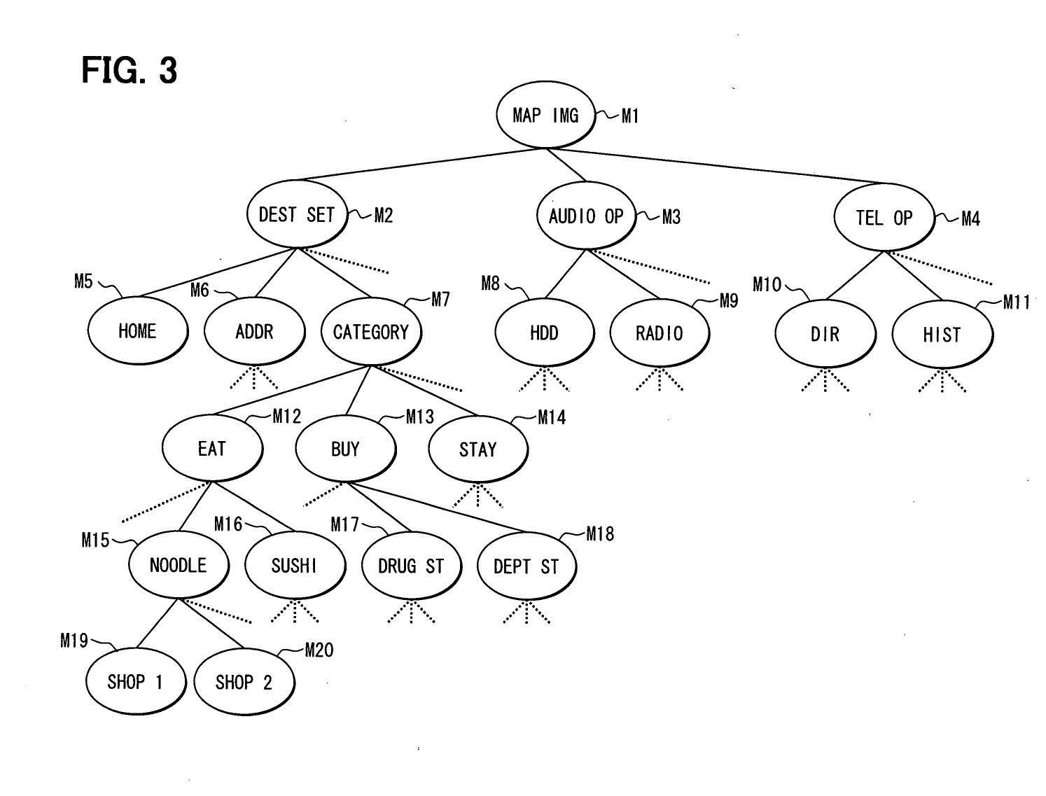

On the screen of the display unit 15, a menu is displayed. The structure of the menu is described based on the illustration in FIG. 3. The menu has more than one menu item (e.g., menu items M1 to M20 in FIG. 3), and each of the menu items forms a tree structure.

Each of the menu items corresponds to one desired function, and displays a screen of the corresponding desired function. For example, a menu item M2 corresponds to a desired function of destination setting, and displays a screen about the destination setting.

The display unit 15 displays only one menu item at a time. The user can go up or go down the menu tree structure by operating the menu operation button 5b of the operation switch 5 on the display unit 15. For example, by user's operation of the menu operation button 5b, the menu item displayed on the display unit 15 switches over from M1 to M2 to M7 to M12 to M15 to M19, and from M19 to M1 in reverse. Each of the menu items is stored in the ROM of the control unit 27.

The screen on the display unit 15 can also display, on the map, the current position of the vehicle together with the navigation route, facility names, landmarks and the like, based on the input from the position detector 3 and the map data input unit 13. The map may also include the facility guide or the like.

The sound output unit 17 (i.e., a speaker) outputs a guidance of a facility and other information, based on the input from the map data input unit 13.

The microphone 19 outputs, to the control unit 27, the electronic signal (i.e., the audio signal) based on the utterance (i.e., voice) of the user. The utterance or the user's voice is utilized by the voice recognition unit 21.

The operation start detector 25 detects that the operation start button 5a is operated, and outputs detection information to the control unit 27.

The voice recognition unit 21 will be mentioned later.

The control unit 27 is composed mainly of a well-known microcomputer which includes a CPU, a ROM, a RAM, and an I/O together with a bus line that connects these components and the like, and executes various processes based on the program memorized in the ROM and the RAM. For example, the vehicle position is calculated as a set of position coordinates and a travel direction based on the detection signal from the position detector 3, and the calculated position is displayed on the map that is retrieved by the map data input unit 13 by the execution of a display process. In addition, the point data stored in the map data input unit 13 and the destination input from the operation switch 5, the remote controller 7 and the like are used to calculate a navigation route from the current vehicle position to the destination by the execution of a route guidance process.

Further, the control unit 27 performs a call placement process that places a call from the communication apparatus 11 when, for example, a call screen to input a telephone number is displayed on the display unit 15, and then the telephone number and a call placement instruction are input from that, screen.

### (2) Configuration of a Voice Recognition Unit 21

As shown in FIG. 2, the voice recognition unit 21 includes a recognition section 29, a function determination section 31, a function memory section 33, a shortcut button generation section 35, a shortcut button display section 37, and a recognition dictionary 39, and an operation information database (DB) 41.

The speech recognition section 29 translates the voice signal from the microphone 19 into digital data. The recognition dictionary 39 stores voice patterns as phoneme data. The speech recognition section 29 outputs a recognition result to the function determination section 31 by recognizing the voice signal in the digital data as a word or a string of words based on the recognition dictionary 39.

The function determination section 31 determines a desired function based on the word or the string of words that are input from the speech recognition section 29.

The operation information DB 41 associates various functions (i.e., the desired functions) such as a navigation operation, a cellular phone operation, a vehicle device operation, a television operation and the like with a word or a string of words, and stores the function-word association. The function determination section 31 determines, from among the functions stored in the operation information DB 41, the desired function that is associated with the input word(s) from the speech recognition section 29, and outputs the desired function to the function memory section 33.

The function memory section 33 outputs, by storing in advance the desired function that is input from the function determination section 31, the desired function to the shortcut button generation section 35 when a certain determination condition is satisfied.

The shortcut button generation section 35 generates a shortcut button that corresponds to the input of the desired function from the function memory section 33, and outputs the shortcut button to the shortcut button display section 37.

The shortcut button display section 37 displays the shortcut button input from the shortcut button generation section 35 on the display unit 15.

### (3) Process Performed by the Control Apparatus 1

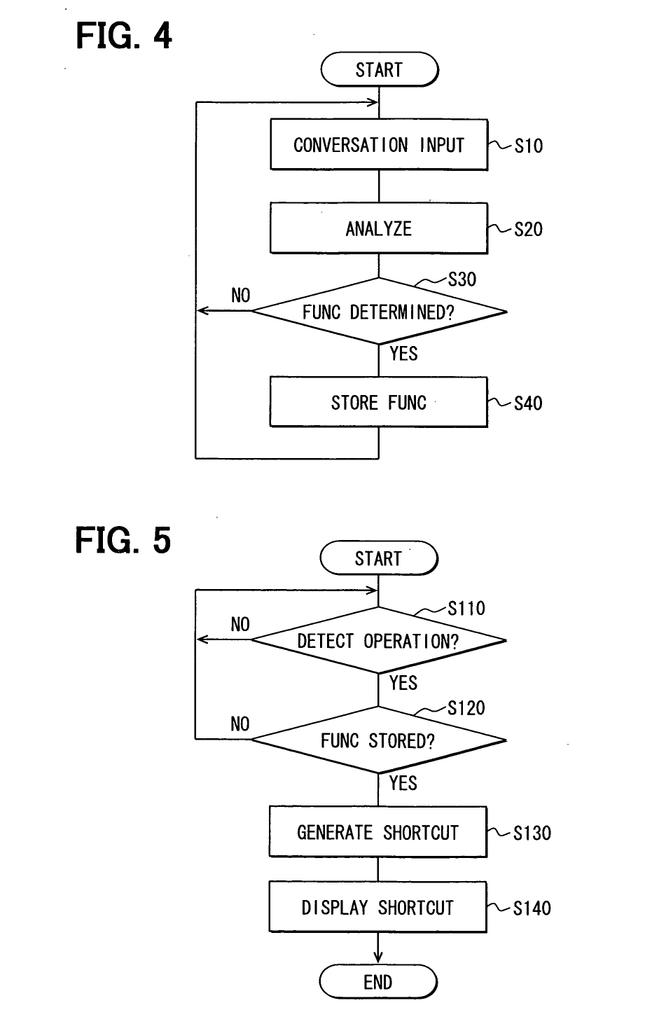

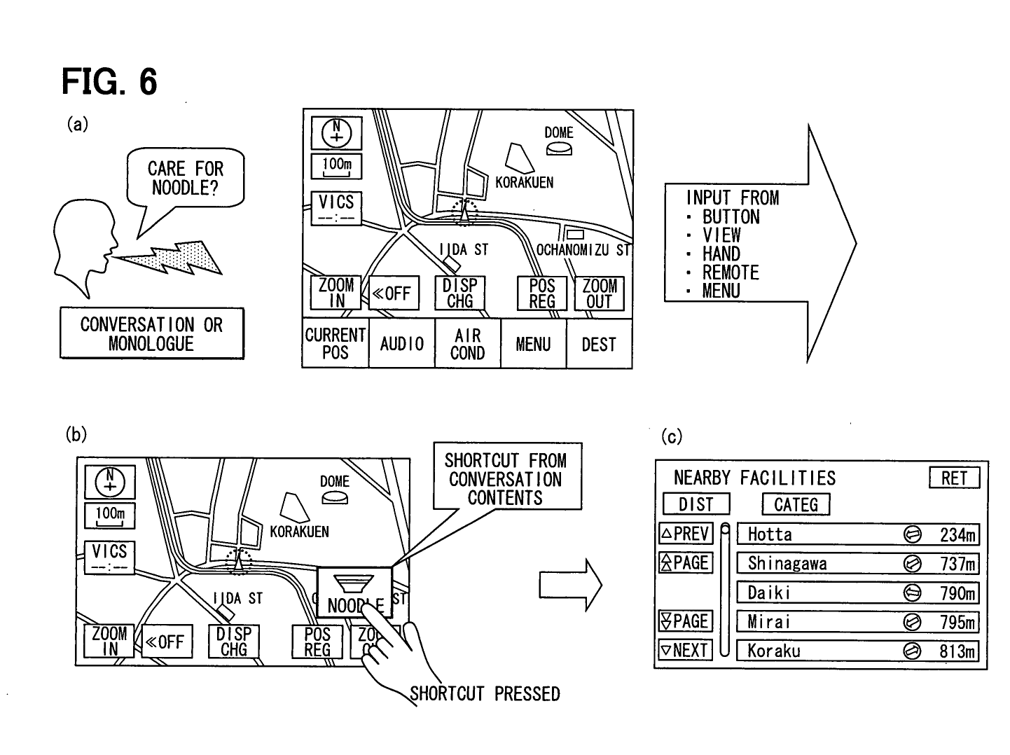

The process executed by the control apparatus 1 is described based on the flowcharts in FIGS. 4 and 5 and the illustration in FIG. 6.

(3-1) FIG. 4 shows a process which is repeated while the power of the control apparatus 1 is turned on.

In Step 10, the process accepts the sound of conversation or monologue which is inputted to the speech recognition section 29 from the microphone 19.

In Step 20, the process resolves the sound which is input to the speech recognition section 29 in Step 10 into the word or the string of words.

In Step 30, the process determines whether a desired function is determined from the word or the string of words resolved in Step 20. That is, if the desired function that is associated with the word resolved in Step 20 is stored in the operation information DB 41, the process determines the desired function based on the stored information, and proceeds to Step 40. If the word resolved in Step 20 is not stored in the operation information DB 41, it is determined that the desired function has not be determined, and the process returns to Step 10.

In Step 40, the process stores the desired function determined in Step 30 in the function memory section 33.

(3-2) FIG. 5 shows a process which is repeatedly executed at a predetermined interval during while the power of the control apparatus 1 is turned on, besides the process shown in FIG. 4.

In Step 110, the process determines whether or not the operation of the button 5a is detected. If the operation is detected, the process proceeds to Step 120, or, if the operation is not detected, the process stays in Step 110.

In Step 120, the process determines whether or not the desired function is stored in the function memory section 33. If the desired function is stored, the process proceeds to Step 130, or if the desired function is not stored, the process returns to Step 110.

In Step 130, the process generates the shortcut button by the shortcut button generation section 35, the button corresponding to the desired function confirmed to be stored in Step 120.

In Step 140, the process displays, the shortcut button display section 37, the shortcut button generated in Step 130 on the display unit 15.

(3-3) An example of the above-described process is shown in FIG. 6. That is, FIG. 6 shows an example of screen transition.

In FIG. 6(a), the user's voice utters “Care for noodle?” in conversation or in monologue. The user's voice is input to the speech recognition section 29 from the microphone 19 in Step 10. The speech recognition section 29 analyzes and resolves the voice into the word or a string of words in Step 20. Further, the speech recognition section 29 determines the desired function based on a part of the word or the string of words. In this case, the word “noodle” is picked up. Then, the desired function in association with the word “noodle” is determined as “Destination setting by Noodle restaurant” in Step 30, and that desired function is stored in the function memory section 33 in Step 40.

Then, upon detecting the user operation of the operation start button 5a (YES in Step 110), a shortcut button for “Destination setting by Noodle restaurant” is generated and displayed on the display unit 15 as shown in FIG. 6(b) in Steps 130, 140, because the desired function is stored in the function memory section 33.

Then, if the user presses the shortcut button, the desired function “Destination setting by Noodle restaurant” is executed to display noodle restaurants in a list form as shown in FIG. 6(c).

### (4) The Advantageous Effects

The control apparatus 1 displays the shortcut button only when the user presses button 5a to start the shortcut button generation/display operation. Therefore, unnecessary shortcut buttons will not be displayed on the screen.

Further, the control apparatus 1 recognizes the user's utterance, outputs the recognized word(s), and determines the desired function to be stored, in a continuous manner while the power of the control apparatus 1 is turned on. In other words, the voice recognition “pre-processing” and the “function determination pre-processing” is “always on” to pre-store the desired function. Therefore, the user needs not separately instruct the start of the voice recognition process or the start of the desired function determination process.

### (5) Modifications

The control apparatus 1 in the present embodiment may be modified in the following manner. The modified apparatus 1 exerts the same advantageous has as the original one.

(5-1) The modified control apparatus 1 has a look recognition unit for recognizing the user's look direction, or the user's view. The look recognition unit may have a configuration disclosed in, for example, a Japanese patent document JP-A-2005-296382. The process in the control apparatus 1 proceeds to Step 120 if the user is determined to be looking at the control apparatus 1, for example in Step 110, or the process stays in Step 110 if the user is not looking at the apparatus 1.

(5-2) The modified control apparatus 1 has a hand detector for recognizing user's hand. The hand detector of well-known type is used to detect that the user's hand is close to the control apparatus 1 in Step 110. If the user's hand is detected to be close to the apparatus 1, the process proceeds to Step 120, or, if the user's hand is not close to the apparatus 1, the process stays in Step 110.

(5-3) The modified control apparatus 1 has a touch detector for detecting a user's touch on the remote controller 7. The touch detector of well-known type is used to detect the touch in Step 110, whether to proceed to Step 120. If a touch is detected, the process proceeds to Step 120, and if a touch is not detected, the process stays in Step 110.

### 2. Second Embodiment

### (1) Configuration of the Control Apparatus 1

As for the control apparatus 1 of the present embodiment, basically, a similar configuration is adopted, thus only the different parts are described. That is, the menu item in the menu (see FIG. 3) may or may not have a shortcut button display area.

### (2) Process Performed in the Control Apparatus 1

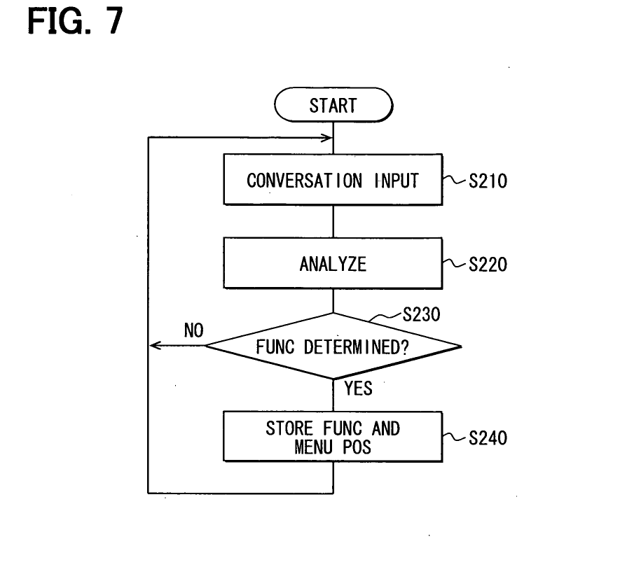

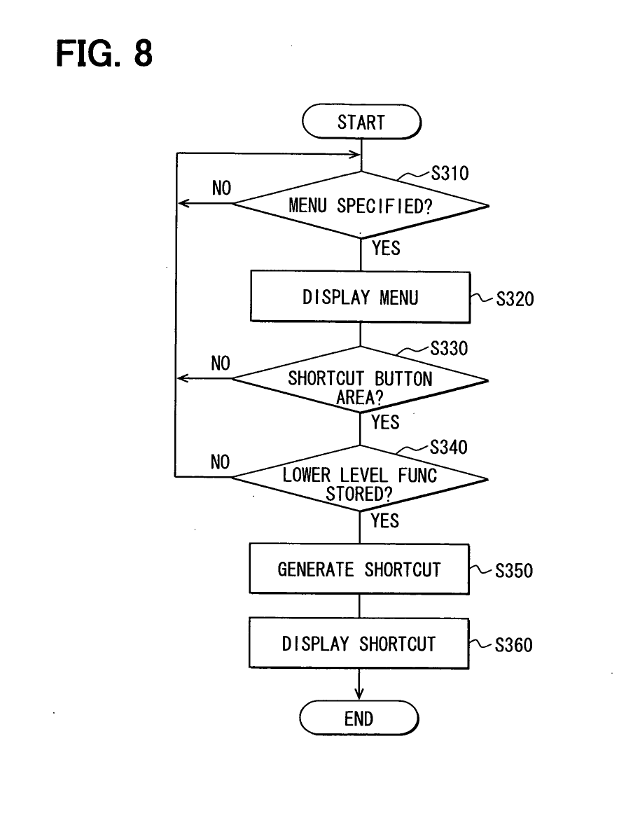

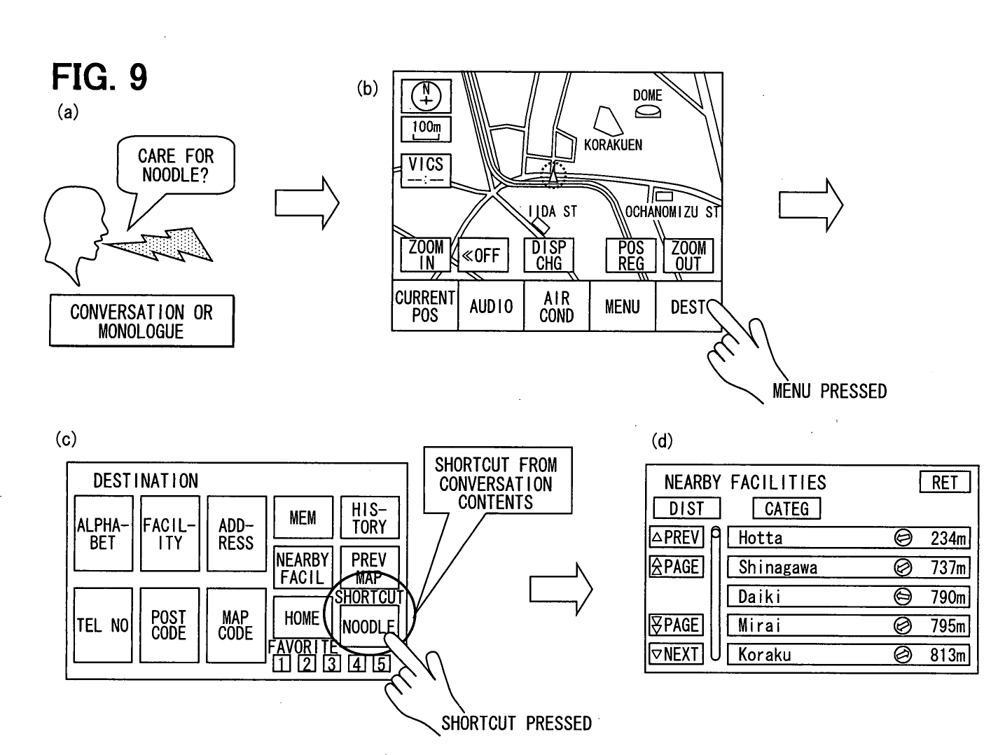

The process which the control apparatus 1 executes is described with reference to a flowchart in FIG. 7, a flowchart in FIG. 8 and an illustration in FIG. 9.

(2-1) The process shown in FIG. 7 is a process that is repeated while the power of the control apparatus 1 is turned on.

In Step 210, the process accepts the sound of conversation or monologue which is input to the speech recognition section 29 from the microphone 19.

In Step 220, the process resolves the input sound in Step 210 in the speech recognition section 29 into the word or the string of words.

In Step 230, the process determines whether it is possible to determine a desired function from the word or the string of words which is resolved in Step 220. That is, if a desired function which is associated with the word or the string of words resolved in Step 220 is stored in the operation information DB 41, it is determined as the desired function, and the process proceeds to Step 240. On the other hand, if a desired function associated with the word or the string of words resolved in Step 220 is not stored in the operation information DB 41, it is determined that the desired function has not been determined, and the process returns to Step 210.

In Step 240, the process stores in the function memory section 33 the desired function which is determined in Step 230. Also, it stores the position of the menu item of the desired function in the menu tree structure in FIG. 3 (designated as a “menu item position” hereinafter). The menu item position determines which hierarchy the menu item of the desired function is displayed. When Step 240 is concluded, the process returns to Step 210.

(2-2) The process shown in FIG. 8 is a process that is repeated at a predetermined interval, separately from the process in FIG. 7, while the power of the control apparatus 1 is turned on.

In Step 310, the process determines whether or not the menu item which is displayed on the display unit 15 is specified by the operation of the menu operation button 5b. In this case, the menu operation button 5b is a button that displays a user desired menu on the display unit 15. Thus, if the menu item is specified, the process proceeds to Step 320, or, if the menu item is not specified, the process stays at Step 310.

In Step 320, the process displays the menu item which is specified by the above-mentioned Step 310 on the display unit 15.

In Step 330, the process determines whether or not the menu item which is displayed in Step 320 is the one which has a shortcut button display area. If the menu item has the shortcut button display area, the process proceeds to Step 340, or, if the menu does not have the shortcut button display area, the process returns to Step 310.

In Step 340, the process determines whether (a) the desired function is stored in the function memory section 33, and (b) the menu item which displays the desired function belongs to a lower hierarchy of the menu item in the menu tree structure, which is displayed in Step 320. If the above two conditions are fulfilled, the process proceeds to Step 350, or, if the two conditions are not fulfilled, the process returns to Step 310.

More practically, one menu item belonging to the lower hierarchy of the other menu item means that the latter menu item can only be reached by going up the menu tree structure from the former menu item. That is, for example, in the menu tree structure shown in FIG. 3, the menu items M19, M15, M12, M7 respectively belong to the lower hierarchy of the menu item M2, and the menu items M8, M10 do not belong to the lower hierarchy of the menu item M2.

In Step 350, the process generates, by using the shortcut button generation section 35, a shortcut button that corresponds to the desired function having been confirmed to be stored in Step 340.

In Step 360, the process displays the shortcut button which is generated in Step 350 on the display unit 15 by using the shortcut button display section 37.

(2-3) The above-mentioned processes (2-1) and (2-2) are explained in detail with reference to the illustration in FIG. 9.

In FIG. 9(a), the user utters “Care for noodle?” in conversation or in monologue. The sound of this utterance is inputted to the speech recognition section 29 from the microphone 19 (in the above-mentioned Step 210). The speech recognition section 29 resolves the sound into the word or the string of words (in the above-mentioned Step 220). Further, the speech recognition section 29 determines the desired function (“Destination setting by Noodle restaurant” in this case) which is associated with the word or the string of words based on the word or the string of words (the word “noodle” in this case) (in the above-mentioned Step 230). Then, the desired function “Destination setting by Noodle restaurant” and the menu item position of the menu item M15 (see FIG. 3) that displays the desired function are stored in the function memory section 33 (in the above-mentioned Step 240).

Then, as the user operates the destination set button (i.e., a part of the menu operation button 5b) to specify the menu item to be displayed on the display unit 15 as shown in FIG. 9(b) (corresponding to YES in Step 310), the menu item M2 (see FIG. 3) for destination setting is displayed on the display unit 15 as shown in FIG. 9(c). The menu item M2 has, in this case, the shortcut button display area (corresponding to YES in Step 330).

Further, because (a) the function memory section 33 stores the desired function “Destination setting by Noodle restaurant” and the menu item position of the menu item M15 that displays that desired function, and (b) the menu item M15 belongs to the lower hierarchy of the menu item M2 (corresponding to YES in Step 340), the shortcut button of the desired function “Destination setting by Noodle restaurant” is displayed on the display unit 15 (in Steps 350 and 360). Then, the user presses the displayed shortcut button to perform the desired function “Destination setting by Noodle restaurant,” as shown in FIG. 9(d).

### (3) Advantageous Effects

The control apparatus 1 displays the shortcut button only when the menu item to be displayed is specified by the user by the operation of the menu operation button 5b. Therefore, displaying unnecessary shortcut buttons one after another is prevented. Further, only the shortcut button of the desired function which is displayed in the lower hierarchy menu item of the user specified menu item is displayed. Therefore, displaying unnecessary shortcut buttons is prevented in an effective manner.

### (4) Modifications

Modification examples of the control apparatus 1 of the present embodiment are described in the following.

(4-1) The function memory section 33 may store multiple desired functions in association with the recognized word or the string of words. That is, one instance of user utterance may lead to the recognition of multiple desired functions, or each of the multiple instances of user utterance may associate one desired function. Further, the control apparatus 1 may store the menu item position of each of the multiple desired functions.

The control apparatus 1 displays the menu item only in the lowest hierarchy, or in the lower most hierarchies, when (a) the multiple desired functions are stored in the function memory section 33 in Step 340 and (b) the menu items of those desired functions belong to the lower hierarchy of the menu item displayed in Step 320 in the menu tree structure.

For example, assuming that the function memory section 33 stores the desired functions of “Destination setting by Category” (a menu item M7), “Destination setting by Eat” (a menu item M12), “Destination setting by Noodle restaurant” (a menu item M15), and the menu item M2 is displayed on the display unit 15.

If the control apparatus 1 is configured to display, as desired function, the shortcut button of the menu item only in the lowest hierarchy in the menu tree structure, the shortcut button of the desired function “Destination setting by Noodle restaurant” is the only one displayed shortcut button, because that menu item M15 is, from among the menu items M7, M12, M15, in the lowest hierarchy in the menu tree structure.

If, in another case, the control apparatus 1 is configured to display, as desired functions, the shortcut buttons of the menu items in the lower most two hierarchies in the menu tree structure, the two shortcut buttons of the desired functions “Destination setting by Noodle restaurant” (M15) and “Destination setting by Eat” (M12) are displayed.

In this manner, only the user desired functions may highly possibly be displayed as the shortcut buttons.

(4-2) The control apparatus 1 may store the time of storage of each of the multiple desired functions in the function memory section 33, beside storing the multiple desired functions and their menu item positions as described in the above in (4-1).

That is, in Step 340, the control apparatus 1 may display only a specified number of newest desired functions (e.g., only one function, or two or more functions) in an order of the storage times of the desired functions, if the multiple menu items of those functions belong to the lower hierarchy of the menu item that is displayed in Step 320.

For example, when the function memory section 33 stores the desired functions of “Destination setting by Category” (a menu item M7), “Destination setting by Eat” (a menu item M12), “Destination setting by Noodle restaurant” (a menu item M15), and the menu item M2 is displayed on the display unit 15. If the desired functions have been stored in an order of earlier storage time from “Destination setting by Category” to “Destination setting by Eat” to “Destination setting by Noodle restaurant,” the control apparatus 1 may display only the newest shortcut button of the desired function “Destination setting by Noodle restaurant,” or may display two newest shortcut buttons of the desired functions “Destination setting by Noodle restaurant” and “Destination setting by Eat,” depending on the configuration.

In this manner, only the user desired functions may highly possibly be displayed as the shortcut buttons.

(4-3) The control apparatus 1 may store multiple desired functions in the function memory section 33 in the above two modifications (4-1) and (4-2). Further, the menu item positions of those menu items are also stored in the memory section 33. Then, in Step 340, the control apparatus 1 may display on the display unit 15 the multiple shortcut buttons of the desired functions stored in the memory section 33, if the menu items of those desired functions belong to the lower hierarchy of the menu item that is displayed in Step 320. In this case, the shortcut buttons may be displayed in a list form. Further, only one shortcut button may be displayed on the display unit 15, or only a few shortcut buttons may be displayed. Further, the shortcut button(s) may be switched as the time elapses. In this manner, the multiple shortcut buttons are displayed in an easily viewable and easily accessible manner.

(4-4) Besides storing the multiple desired functions and menu item positions, the number of the desired functions stored in the function memory section 33 may have an upper limit. That is, the desired functions may be stored in the memory section 33 up to a limited number, and after storing the limited number of desired functions, the oldest desired function in the memory section 33 may be erased for newly storing one desired function.

In this manner, displaying an excessive number of the shortcut buttons is prevented.

(4-5) If a predetermined period of time has elapsed without displaying the desired function since the desired function is stored in the function memory section 33, the desired function may be automatically erased from the memory section 33 (i.e., a function erase function may be provided as “means”).

In this manner, the unnecessary shortcut buttons are prevented from being displayed.

In the present modification example, it is possible to prevent the display of the shortcut button which is unnecessary for the user.

(4-6) The desired functions may be erased from the function memory section 33 according to the operation of the operation switch 5. That is, a part of the desired functions stored in the memory section 33, or all of the stored functions in the function memory section 33, may be erased by the user operation.

In this manner, the unnecessary shortcut buttons are prevented from being displayed.

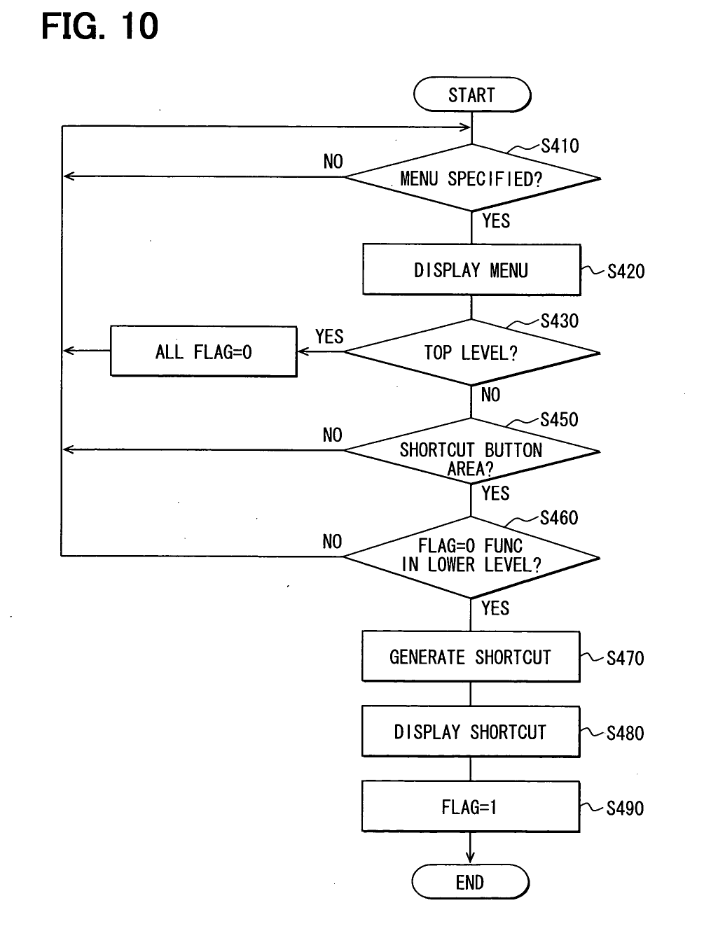

(4-7) The control apparatus 1 may set a shortcut generation flag for each of the desired functions stored in the function memory section 33. The value of the shortcut generation flag is either 0 or 1. Further, the control apparatus 1 may execute a process shown in FIG. 10 instead of the process in FIG. 8.

The process shown in this FIG. 10 is described in the following. The process determines, in Step 410, whether or not the menu item which is displayed on the display unit 15 is specified by the operation of the menu operation button 5b. If the menu item is specified, the process proceeds to Step 420, or if the menu item is not specified, the process stays at Step 410.

In Step 420, the process display's, on the display unit 15, the menu item which is specified in the above-mentioned Step 410.

In Step 430, the process determines whether or not the menu item which is displayed in Step 420 is the highest menu item in the menu tree structure (e.g., corresponding to M1 in FIG. 3). If the displayed item is in the highest hierarchy in the menu tree structure, the process proceeds to Step 440, and the shortcut generation flags for all of the desired functions stored in the function memory section 33 are set to 0. If, on the other hand, the displayed item is not in the highest hierarchy in the menu tree structure, the process proceeds to Step 450.

In Step 450, the process determines whether or not the menu item which is displayed in Step 420 is the one which has the shortcut button display area. If the menu item has the shortcut button display area, the process proceeds to Step 460. If the menu item does not have the shortcut button display area, the process returns to Step 410.

In Step 460, the process determines whether there is a desired function that is stored in the function memory section 33, having the corresponding menu item in the lower hierarchy of the menu item displayed in Step 420, with its shortcut generation flag set to 0. If there is a fulfilling desired function, the process proceeds to Step 470, or, if there is no such desired function, the process returns to Step 410.

In Step 470, the process generates a shortcut button for that fulfilling desired function determined in Step 460 by using the shortcut button generation section 35.

In Step 480, the process displays the shortcut button which is generated in Step 470 on the display unit 15 by using the shortcut button display section 37.

In Step 490, the process sets the shortcut generation flag of the desired function which is displayed in Step 470 to 1.

In this manner, the desired function whose shortcut button is displayed has the shortcut generation flag of 1 (in Step 490), thereby, in Step 460, being determined that there is no such desired function. Therefore, repeated generation of a shortcut button for the same desired function is prevented.

### 3. Third Embodiment

### (1) Configuration of the Control Apparatus 1

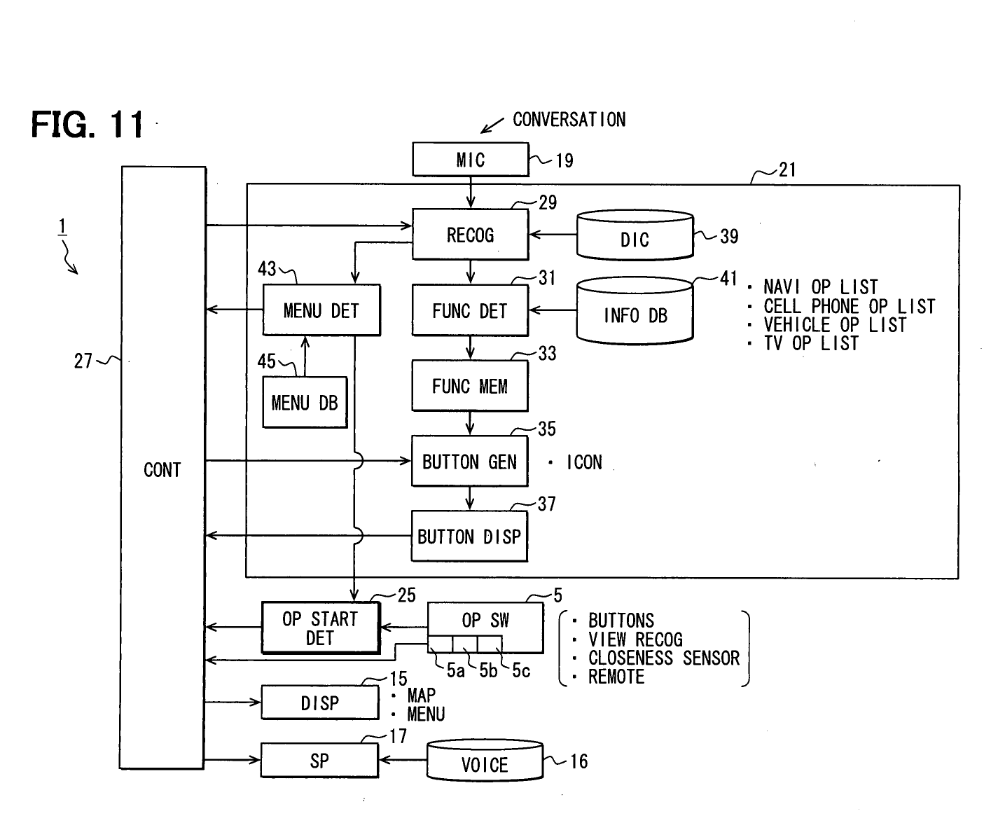

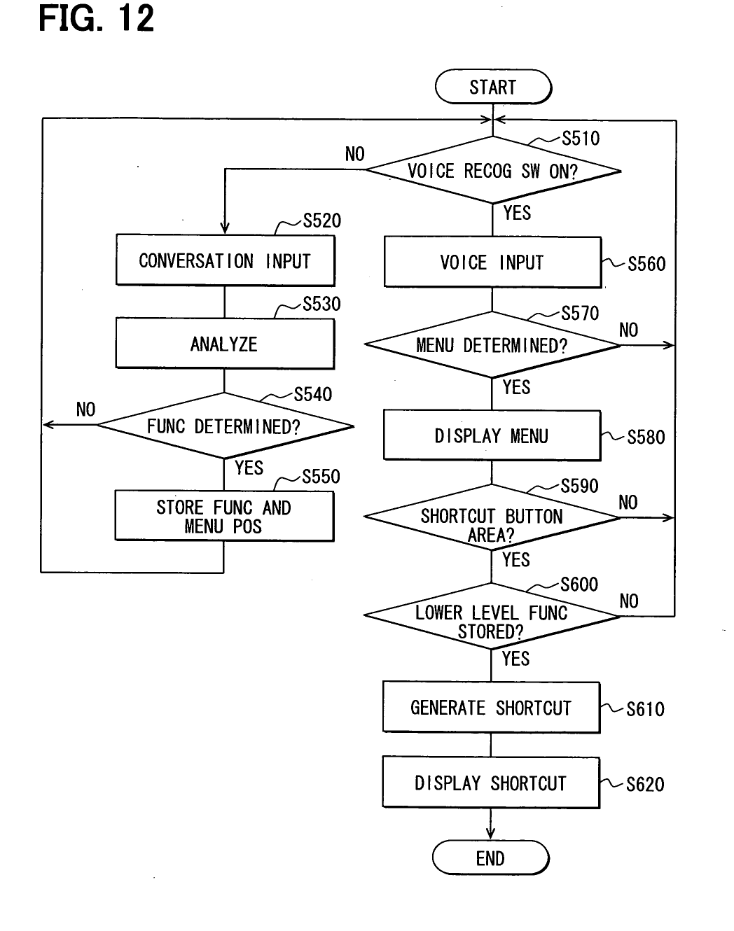

The configuration of the control apparatus 1 of the present embodiment is described with reference to FIG. 11. The control apparatus 1 has basically the same configuration as the control apparatus of the second embodiment, with the addition of a voice recognition start switch 5c.

Further, the control apparatus 1 has a menu item determination unit 43 and a menu item database (DB) 45. The menu item determination unit 43 receives an input of voice recognition results of the word or the string of words from the recognition section 29, and determines the menu item based on the input of the recognition result. The menu item DB 45 stores menu items M1 to M20 and the like in association with the word or the string of words. The menu item determination unit 43 determines the menu item, from among the menu items stored in the menu item DB 45, which is associated with the word or the string of words input from the recognition section 29, and outputs the determined menu item to the operation start detection section 25 and the control unit 27.

### (2) Process Performed by the Control Apparatus 1

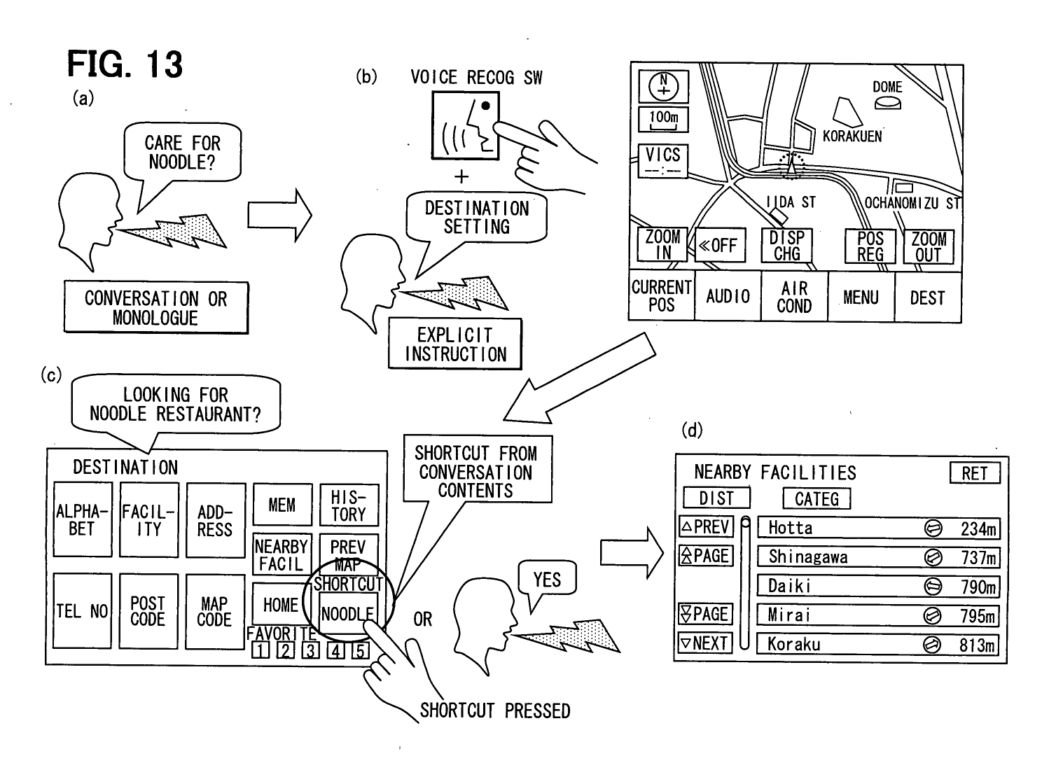

The process performed by the control apparatus 1 is described' with reference to the flowchart in FIG. 12 and the illustration in FIG. 13.

(2-1) FIG. 12 shows a process which is repeated while the power of the control apparatus 1 is turned on.

In Step 510, the process determines whether or not the voice recognition start switch 5c is pressed. If it is determined that the switch 5c is not pressed, the process proceeds to Step 520, or, if it is determining that the switch 5c is pressed, the process proceeds to Step 560.

In Step 520, the process accepts the sound of conversation or monologue which is inputted to the speech recognition section 29 from the microphone 19.

In Step 530, the process resolves the sound which is input in Step 520 to the speech recognition section 29 into the word or the string of words.

In Step 540, the process determines whether it is possible to determine a desired function from the word or the string of words which is resolved in Step 530.

That is, if the desired function which is associated with the word or the string of words resolved in Step 530 is stored in the operation information DB 41, the process determines the matching function as the desired function, and the process proceeds to Step 550.

On the other hand, if the desired function which is associated with the word or the string of words resolved in Step 530 is not stored in the operation 5, information DB 41, it is determined that the desired function is not determined, and the process returns to Step 510.

In Step 550, the process stores the desired function which is determined in Step 540 in the function memory section 33, together with the menu item position of the desired function. After Step 550, the process returns to Step 510.

If the voice recognition start switch 5c is determined to have been pressed in Step 510, the process proceeds to Step 560. In Step 560, the process accepts the sound of conversation or monologue which is inputted to the speech recognition section 29 from the microphone 19, just like the above-mentioned Step 520.

In Step 570, the process resolves the sound which is input in Step 560 to the speech recognition section 29, just like the above-mentioned Step 530, into the word or the string of words. Then, the process determines whether it is possible to determine a menu item from the word or the string of words by using menu determination unit 43. That is, if a menu item which is associated with the resolved word or the string of words is stored in the menu item DB 45, the process determines it as the menu item, and the process proceeds to Step 580. On the other hand, if no menu item which is associated with the resolved word or the string of words is stored in the menu item DB 45, the process determines that no menu item is determined, and the process returns to Step 510.

In Step 580, the process displays, on the display unit 15, the menu item which is determined in Step 570.

In Step 590, the process determines whether or not the menu item which is displayed in Step 580 is the one which has the shortcut button display area. If the menu item has the shortcut button display area, the process proceeds to Step 600, or if the menu item does not have the shortcut button display area, the process returns to Step 510.

In Step 600, the process determines whether (a) the desired function is stored in the function memory section 33, and (b) the menu item which displays the desired function belongs to a lower hierarchy of the menu item in the menu tree structure, which is displayed in Step 580. If the above two conditions are fulfilled, the process proceeds to Step 610, or, if the two conditions are not fulfilled, the process returns to Step 510.

In Step 610; the process generates, by using the shortcut button generation section 35, a shortcut button that corresponds to the desired function having been confirmed to be stored in Step 600.

In Step 620, the process displays, on the display unit 15, the shortcut button which is generated in Step 610 by using the shortcut button display section 37.

(2-2) The above-mentioned process (2-1) is explained in detail with reference to the illustration in FIG. 13.

In FIG. 13(a), the user utters “Care for noodle?” in conversation or in monologue in a condition that the voice recognition start switch 5c has not yet been pressed (i.e., corresponding to NO in Step 510). The sound of this utterance is inputted to the speech recognition section 29 from the microphone 19 (in the above-mentioned Step 520). The speech recognition section 29 resolves the sound into the word or the string of words (in the above-mentioned Step 530). Further, the speech recognition section 29 determines the desired function (“Destination setting by Noodle restaurant” in this case) which is associated with a part of the resolved word or the string of words (the word “noodle” in this case) (in Step 540). Then, the desired function “Destination setting by Noodle restaurant” and the menu item position of the menu item M15 (see FIG. 3) that displays the desired function are stored in the function memory section 33 (in Step 550).

Then, as shown in FIG. 13(b), the user presses the voice recognition start switch 5c (YES in Step 510), and utters “Destination setting.” The sound of this utterance is inputted to the speech recognition section 29 from the microphone 19 (Step 560). The speech recognition section 29 resolves the sound into the word or the string of words, just like Step 530. The menu item determination unit 43 determines the menu item (the menu item M2 of “Destination setting” in this case) which is associated with a part of the word or the string of words based on the resolved word or the string of words (“Destination setting” in this case) (Step 570).

Then, the menu item M2 of the destination setting is displayed on the display unit 15 (Step 580). It is assumed that the menu item M2 is a menu item which has a shortcut button display area (YES in Step 590). Further, because (a) the function memory section 33 stores the desired function “Destination setting by Noodle restaurant” and the menu item position of the menu item M15 that displays that desired function, and (b) the menu item M15 belongs to the lower, hierarchy of the menu item M2 (corresponding to YES in Step 600), the shortcut button of the desired function “Destination setting by Noodle restaurant” is displayed on the display unit 15 as shown in FIG. 13(c) (in Steps 610 and 620). Then, the user presses the displayed shortcut button to perform the desired function “Destination setting by Noodle restaurant,” as shown in FIG. 13(d).

### (3) Advantageous Effects

The control apparatus 1 has the same advantages as the control apparatus 1 of the second embodiment. In addition, the ease of operation of the control apparatus 1 is further improved by allowing the user to specify, by voice, the menu item to be displayed. That is, in other words, an explicit voice instruction to specify a menu item is allowed, as shown in FIG. 13(b).

### (4) Modifications

The modification examples of the control apparatus 1 of the present embodiment are described in the following.

(4-1) The control apparatus 1 may output the name of the desired function (i.e., talk-back) when displaying the shortcut button of the desired function. That is, for example, when displaying the shortcut button of “Destination setting by Noodle restaurant,” the talk-back may sound like “Is it OK to perform Destination setting by Noodle restaurant?”

Further, the control apparatus 1 may perform the desired function that corresponds to the shortcut button when the user's answer by voice is a predetermined one (e.g., “Yes”) after the talk-back.

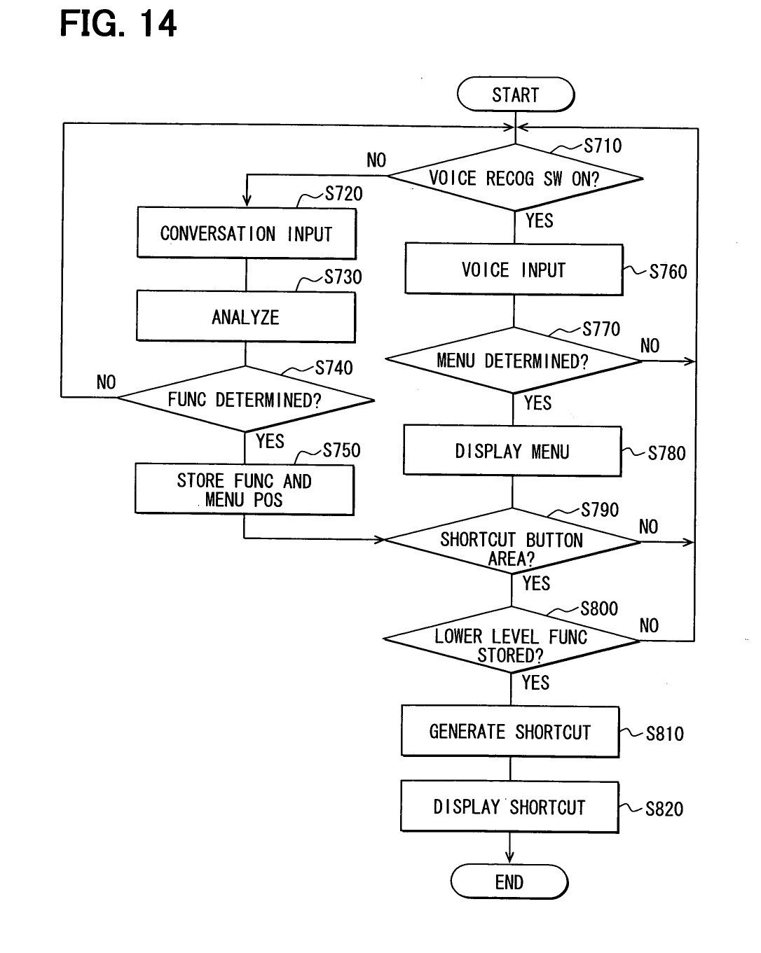

(4-2) The control apparatus 1 may perform a process shown in FIG. 14 instead of the process shown in FIG. 12.

The process of FIG. 14 is described in the following.

In Step 710, the process determines whether or not the voice recognition start switch 5c is pressed. If it is determined that the switch 5c is not pressed, the process proceeds to Step 720, or, if it is determining that the switch 5c is pressed, the process proceeds to Step 760.

In Step 720, the process accepts the sound of conversation or monologue which is inputted to the speech recognition section 29 from the microphone 19.

In Step 730, the process resolves the sound which is input in Step 720 to the speech recognition section 29 into the word or the string of words.

In Step 740, the process determines whether it is possible to determine a desired function from the word or the string of words which is resolved in Step 730. That is, if the desired function which is associated with the word or the string of words resolved in Step 730 is stored in the operation information DB 41, the process determines the matching function as the desired function, and the process proceeds to Step 750. On the other hand, if the desired function which is associated with the word or the string of words resolved in Step 730 is not stored in the operation information DB 41, it is determined that the desired function is not determined, and the process returns to Step 710.

In Step 750, the process stores the desired function which is determined in Step 740 in the function memory section 33, together with the menu item position of the desired function. After Step 750, the process proceeds to Step 790.

On the other hand, if the voice recognition start switch 5c is determined to have been pressed in Step 710, the process proceeds to Step 760. In Step 760, the process accepts the sound of conversation or monologue which is inputted to the speech recognition section 29 from the microphone 19, just like the above-mentioned Step 720.

In Step 770, the process resolves the sound which is input in Step 760 to the speech recognition section 29, just like the above-mentioned Step 730, into the word or the string of words. Then, the process determines whether it is possible to determine a menu item from the word or the string of words by using menu determination unit 43. That is, if a menu item which is associated with the resolved word or the string of words is stored in the menu item DB 45, the process determines it as the menu item, and the process proceeds to Step 780. On the other hand, if no menu item which is associated with the resolved word or the string of words is stored in the menu item DB 45, the process determines that no menu item is determined, and the process returns to Step 710.

In Step 780, the process displays, on the display unit 15, the menu item which is determined in Step 770.

In Step 790, the process determines whether or not the menu item which is displayed in Step 780 is the one which has the shortcut button display area. If the menu item has the shortcut button display area, the process proceeds to Step 800, or if the menu item does not have the shortcut button display area, the process returns to Step 710.

In Step 800, the process determines whether (a) the desired function is stored in the function memory section 33, and (b) the menu item which displays, the desired function belongs to a lower hierarchy of the menu item in the menu tree structure, which is displayed in Step 780. If the above two conditions are fulfilled, the process proceeds to Step 810, or, if the two conditions are not fulfilled, the process returns to Step 710.

In Step 810, the process generates, by using the shortcut button generation section 35, a shortcut button that corresponds to the desired function having been confirmed to be stored in Step 800.

In Step 820, the process displays, on the display unit 15, the shortcut button which is generated in Step 810 by using the shortcut button display section 37.

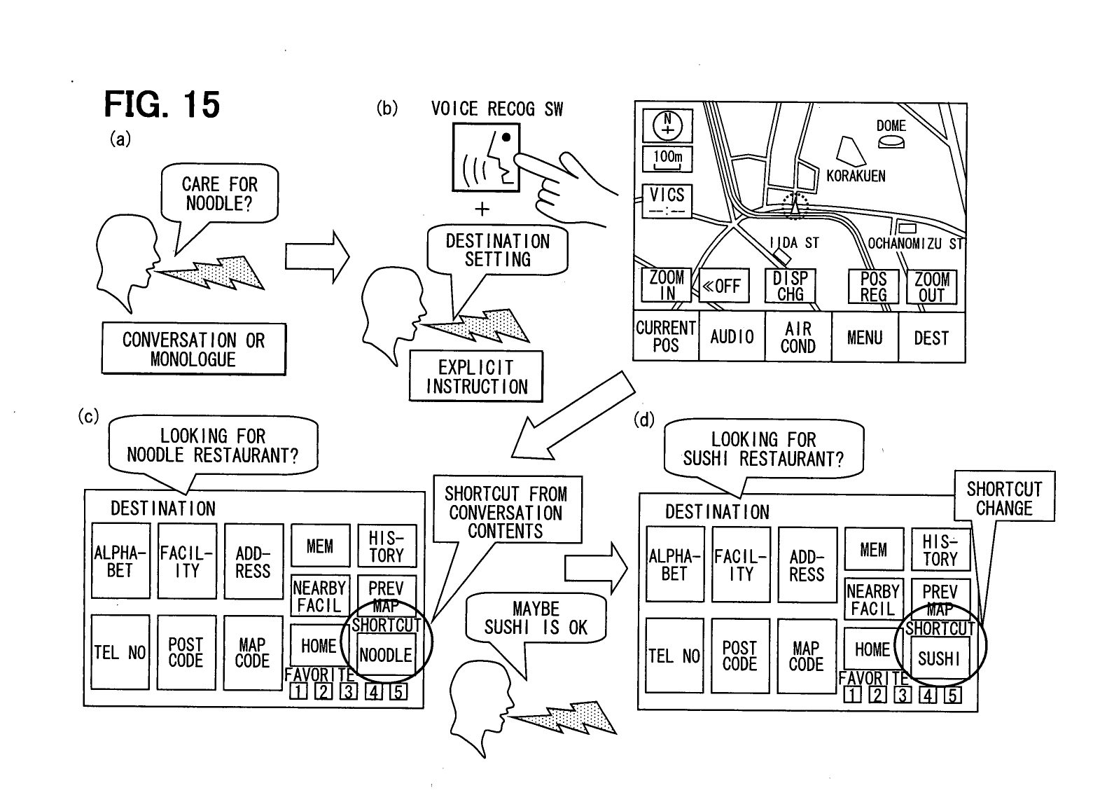

The above-mentioned modified process is explained in detail with reference to the illustration in FIG. 15.

In FIG. 15(a), the user utters “Care for noodle?” in conversation or in monologue in a condition that the voice recognition start switch 5c has not yet been pressed (i.e., corresponding to NO in Step 710). The sound of this utterance is inputted to the speech recognition section 29 from the microphone 19 (in Step 720). The speech recognition section 29 resolves the sound into the word or the string of words (in Step 730). Further, the speech recognition section 29 determines the desired function (“Destination setting by Noodle restaurant” in this case) which is associated with a part of the resolved word or the string of words (the word “noodle” in this case) (in Step 740). Then, the desired function “Destination setting by Noodle restaurant” and the menu item position of the menu item M15 (see FIG. 3) that displays the desired function are stored in the function memory section 33 (in Step 750).

Then, as shown in FIG. 15(b), the user presses the voice recognition start switch 5c (YES in Step 710), and utters “Destination setting.” The sound of this utterance is inputted to the speech recognition section 29 from the microphone 19 (Step 760). The speech recognition section 29 resolves the sound into the word or the string of words, just like Step 730. The menu item determination unit 43 determines the menu item (the menu item M2 of Destination setting in this case) which is associated with a part of the word or the string of words based on the resolved word or the string of words (“Destination setting” in this case) (Step 770).

Then, the menu item M2 of the destination setting is displayed on the display unit 15. It is assumed that the menu item M2 is a menu item which has a shortcut button display area (corresponding to YES in Step 790). Further, because (a) the function memory section 33 stores the desired function “Destination setting by Noodle restaurant” and the menu item position of the menu item M15 that displays that desired function, and (b) the menu item M15 belongs to the lower hierarchy of the menu item M2 (corresponding to YES in Step 800), the shortcut button of the desired function “Destination setting by Noodle restaurant” is displayed on the display unit 15 as shown in FIG. 15(c) (in Steps 810 and 820).

Then, the user utters “Maybe Sushi is OK” in conversation or in monologue in a condition that the voice recognition start switch 5c has not yet been pressed (i.e., corresponding to NO in Step 710). After the utterance, the desired function of “Destination setting by Sushi restaurant” and a menu item position of a menu item M16 (see FIG. 3) of the desired function are stored in the function memory section 33 by the process of Steps 720 to 750. Then, by the process of Steps 790 to 820, a shortcut button of the desired function “Destination setting by Sushi restaurant” is displayed, and a shortcut button of the desired function “Destination setting by Noodle restaurant” is erased, as shown in FIG. 15(d).

In this manner, the shortcut button is easily updated to the latest one, which reflects an “up-to-the-minute” user need.

Such changes, modifications, and summarized schemes are to be understood as being within the scope of the present disclosure as defined by appended claims.

What is claimed is:

1. A control apparatus comprising:
a voice recognition unit for recognizing a user voice to output a word or a string of words;
a function storage unit for determining and storing a function that corresponds to the word or the string of words recognized by the voice recognition unit;
a detector for detecting a preset user operation;
a button display unit for displaying on a screen a shortcut button that instructs execution of the function stored in the function storage unit when the detector detects the preset user operation; and
a control unit for controlling execution of the function when the shortcut button is operated.

2. The control apparatus of claim 1 further comprising:
a menu storage unit for storing a menu that has a tree structure of multiple menu items, each of which displays the function; and
a menu display unit for displaying a relevant menu according to an operation by a user, wherein
the button display unit displays on the screen the shortcut button that instructs execution of the function stored in the function storage unit if both of the following two conditions (a) and (b) are fulfilled:
(a) the detector detects as the preset operation the user operation of the menu, and
(b) the function stored in the function storage unit is a function of a lower menu item of a menu item that is displayed by the menu display unit.

3. The control apparatus of claim 2 wherein
the user operation of the menu is a voice instruction of a specific menu item, and
the menu display unit displays the specific menu item by voice-recognizing the voice instruction of the specific menu item.
